(19) United States
(12) Patent Application Publication
(10) Pub. No.: US 2013/0243314 A1
(43) Pub. Date: Sep. 19, 2013

(54) METHOD AND SYSTEM FOR REAL-TIME IMAGES FOREGROUND SEGMENTATION

(71) Applicants: Jaume Civit, Madrid (ES); Oscar Divorra, Madrid (ES)

(72) Inventors: Jaume Civit, Madrid (ES); Oscar Divorra, Madrid (ES)

(73) Assignee: TELEFONICA, S.A., Madrid (ES)

(21) Appl. No.: 13/877,060

(22) PCT Filed: Aug. 11, 2011
(86) PCT No.: PCT/EP11/04020

§ 371 Date: May 29, 2013

(30) Foreign Application Priority Data
Oct. 1, 2010 (ES) P201001263

(51) Int. Cl. G06T 7/00

(52) U.S. Cl. CPC G06T 7/0079
USPC 382/164

(57) ABSTRACT

The method comprises:
generating a set of cost functions for foreground, background and shadow segmentation classes or models, where the background and shadow segmentation costs are based on chromatic distortion and brightness and colour distortion; and
applying to the pixels of an image said set of generated cost functions;

The method further comprises, in addition to a local modelling of foreground, background and shadow classes carried out by said cost functions, exploiting the spatial structure of content of at least said image in a local as well as more global manner; this is done such that local spatial structure is exploited by estimating pixels' costs as an average over homogeneous colour regions, and global spatial structure is exploited by the use of a regularization optimization algorithm.

The system is adapted to implement at least part of the method.

### FIELD OF THE ART

The present invention generally relates, in a first aspect, to a method for real-time images foreground segmentation, based on the application of a set of cost functions, and more particularly to a method which comprises exploiting a local and a global spatial structure of one or more images.

A second aspect of the invention relates to a system adapted to implement the method of the first aspect, preferably by parallel processing.

### PRIOR STATE OF THE ART

There are several systems or frameworks which require robust and good real-time images foreground segmentation, being immersive video-conferencing and digital 3D object capture two main use case frameworks, which will be described next.

### Immersive Video-Conferencing:

In recent years, significant work has been performed in order to push forward visual communications and media towards a next level. Having reached a certain plateau of maturity in what 2D visual quality and definition concerns, 3D seems to be the next stage in what reality and visual experience respects. After a number of technologies, such as broadband Internet, high quality HD low-delay video compression, have become mature enough, several products have been able to irrupt into the market establishing a solid step forward towards practical Telepresence solutions. Among them, we can count large format videoconferencing systems from major providers such as Cisco Telepresence, HP Halo, Polycom, etc. However, current systems still suffer from fundamental imperfections that are known to be detrimental to the communication process. When communicating, eye contact and gaze cues are essential elements of visual communication, and of importance for signalling attention, and managing conversational flow [1, 2]. Nevertheless, current Telepresence systems make it difficult for a user, mainly in many-to-many conversations, to really feel whether someone is actually looking at him/her (rather than someone else) or not, or where/who a given gesture is actually aimed at. In short, body language is still poorly transmitted by communication systems nowadays. Many-to-many communications are expected to greatly benefit from mature auto-stereoscopic 3D technology; allowing people to engage more natural remote meetings, with better eye-contact and better spatiality feeling. Indeed, 3D spatiality, object and people volume and multi-perspective nature, and depth, are very important cues that are missing in current systems. Telepresence is thus a field waiting for mature solutions for real-time free-viewpoint (or multiperspective) 3D video (e.g. based on several View+Depth data sets).

Given current state of the art, accurate and high quality 3D depth generation in real-time is still a difficult task. Some sort of foreground segmentation is often necessary at the acquisition in order to generate 3D depth maps with high enough resolution and accurate object boundaries. For this, one needs flicker-less foreground segmentation, accurate to borders, resilient to noise and foreground shade changes, as well as able to operate in real-time on performing architectures such as GPGPUs.

### Digital 3D Object Capture:

Another use case framework is that one concerning the generation of 3D digital volumes of objects or persons. This is often encountered in applications for 3D people avatar capture, or multi-view 3D capture by using techniques known such as Visual Hull. In this application framework, it is necessary to recover multiple silhouettes (several from different points of view) of a subject or object. These silhouettes are then combined and used in order to render the 3D volume. Foreground segmentation is required as a tool to generate these silhouettes.

### Technical Background/Existing Technology

Foreground segmentation has been studied from a range of points of view (see references [3, 4, 5, 6, 7]), each having its advantages and disadvantages concerning robustness and possibilities to properly fit within a GPGPU. Local, pixel based, threshold based classification models [3, 4] can exploit the parallel capacities of GPU architectures since they can be very easily fit within these. On the other hand, they lack robustness to noise and shadows. More elaborated approaches including morphology post-processing [5], while more robust, they may have a hard time exploiting GPUs due to their sequential processing nature. Also, these use strong assumptions with respect to objects structure, which turns into wrong segmentation when the foreground object includes closed holes. More global-based approaches can be a better fit such that [6]. However, the statistical framework proposed is too simple and leads to temporal instabilities of the segmented result. Finally, very elaborated segmentation models including temporal tracking [7] may be just too complex to fit into real-time systems.
[3]: Is a non-parametric background model and a background subtraction approach. The model aims at handling situations where the background of the scene is cluttered and not completely static but contains small motions such as tree branches and bushes. The model estimates the probability of observing pixel intensity values based on a sample of intensity values for each pixel. The model aims at adapting quickly to changes in the scene which aims at sensitive detection of moving targets. The model can use colour information to suppress detection of shadows.
[4]: Is an algorithm for detecting moving objects from a static background scene that contains shading and shadows using colour images. It is based on background subtraction that aims at coping with local illumination changes, such as shadows and highlights, as well as global illumination changes. The algorithm is based on a proposed computational colour model which separates the brightness from the chromaticity component.
[5]: This scheme performs shadows (highlights) detection using both colour and texture cues. The technique includes also the use of is morphological reconstruction steps in order to reduce noise and misclassification. This is done by assuming that the object shapes are properly defined along most part of their contours after the initial detection, and considering that objects are closed contours with no holes inside.
[6]: Proposes a global method that classifies each pixel by finding the best possible class (foreground, background, shadow) according to a pixel-wise modelling scheme that is optimized globally by Belief Propagation. Global optimization reduces the need for additional post-processing.
[7]: Uses an extremely complex model for foreground and background with motion tracking included, that helps improve the performance of segments classification for foreground/background, while exploiting to some extend the structure of picture objects.
   Problems with Existing Solutions

In general, current solutions have trouble on putting together, good, robust and flexible foreground segmentation with computational efficiency. Either methods available are too simple, either they are excessively complex, trying to account for too many factors in the decision whether some amount of picture data is foreground or background. This is the case for the overview of the state of the art here exposed. See a discussion one by one:
[3]: The approach, given the flexibility at which it is aimed and the simple models for classification that this uses (without global optimization nor considering geometry of the picture) is quite prone to false classifications and outliers.
[4]: The approach, given the flexibility at which it is aimed and the simple models for classification that this uses (without global optimization nor considering geometry of the picture) is quite prone to false classifications and outliers. This approach just considers pixel-wise models and is based on simple shareholding decisions, which in the end make it not very robust and very subject to the influence of noise, resulting in distorted object shapes.
[5]: The approach, a bit more robust than previous ones, is conditioned by the noise cumulated from the first step, where pixel-wise models are just considered without further optimization, and with simple shareholding decisions. The model of object used for morphological post-processing introduces errors when the object has holes and cannot be considered a fully closed contour.
[6]: The approach uses excessively simplified models for background, foreground and shadow which imply some temporal instability in the classification as well as errors (a lack of robustness in shadow/foreground classification is very present). The global optimization exploits some structure of the picture but with limited extend, implying that segment borders may be imprecise in shape.
[7]: The approach is so complicated that it is totally inappropriate for real-time efficient operation.

### DESCRIPTION OF THE INVENTION

It is necessary to offer an alternative to the state of the art which covers the gaps found therein, overcoming the limitations expressed here above, allowing having a segmentation framework for GPU enabled hardware with improved quality and high performance.

To that end, the present invention provides, in a first aspect, a method for real-time images foreground segmentation, comprising:
generating a set of cost functions for foreground, background and shadow segmentation classes, where the background and shadow segmentation costs are based on chromatic distortion and brightness and colour distortion, and where said cost functions are related to probability measures of a given pixel or region to belong to each of said segmentation classes; and
applying to the pixels of an image said set of generated cost functions.

The method of the first aspect of the invention differs, in a characteristic manner, from the prior art methods, in that it comprises, in addition to a local modelling of foreground, background and shadow classes carried out by said cost functions, exploiting the spatial structure of content of at least said image in a local as well as more global manner; this is done such that local spatial structure is exploited by estimating pixels' costs as an average over homogeneous colour regions, and global spatial structure is exploited by the use of a regularization optimization algorithm.

For an embodiment, the method of the invention comprises applying a logarithm operation to the probability expressions obtained according to a Bayesian formulation in order to derive additive costs.

According to an embodiment, the mentioned estimating of pixels' costs is carried out by the next sequential actions:

i) over-segmenting the image using a homogeneous colour criteria based on a k-means approach;

ii) enforcing a temporal correlation on k-means colour centroids, in order to ensure temporal stability and consistency of homogeneous segments,

iii) computing said cost functions per colour segment; and said global spatial structure is exploited by:

iv) using an optimization algorithm to find the best possible global solution by optimizing costs.

In the next section different embodiments of the method of the first aspect of the invention will be described, including specific cost functions defined according to Bayesian formulations, and more detailed descriptions of said steps i) to iv).

The present invention thus provides a robust, real-time and differential (with respect to the state of the art) method and system for Foreground Segmentation. The two main use case frameworks explained above are two possible use cases of the method and system of the invention, which can be, among other, as an approach used within the experimental immersive 3D Telepresence systems [8, 1], or 3D digitalization of objects or bodies.

As disclosed above, the invention is based on a costs minimization of a set of probability functionals (i.e. foreground, background and shadow) by means, for an embodiment, of Hierarchical Belief Propagation.

For some embodiments, which will be explained in detail in a subsequent section, the method includes outlier reduction by regularization on over-segmented regions. An optimization stage is able to close holes and minimize remaining false positives and negatives. The use of a k-means over-segmentation framework enforcing temporal correlation for colour centroids helps ensure temporal stability between frames. In this work, particular care in the re-design of foreground and background cost functionals has also been taken into account in order to overcome limitations of previous work proposed in the literature. The iterative nature of the approach makes it scalable in complexity, allowing it to increase accuracy and picture size capacity as commercial GPGPUs become faster and/or computational power becomes cheaper in general.

A second aspect of the invention provides a system for real-time images foreground segmentation, comprising one or more cameras, processing means connected to the camera, or cameras, to receive images acquired there by and to process them in order to carry out a real-time images foreground segmentation.

The system of the second aspect of the invention differs from the conventional systems, in a characteristic manner, in that the processing means are intended for carrying out the foreground segmentation by hardware and/or software elements implementing at least part of the actions of the method of the first aspect.

### BRIEF DESCRIPTION OF THE DRAWINGS

The previous and other advantages and features will be more fully understood from the following detailed description of embodiments, some of which with reference to the attached drawings, which must be considered in an illustrative and non-limiting manner, in which:

FIG. 1 shows schematically the functionality of the invention, for an embodiment where a foreground subject is segmented out of the background;

FIG. 2 is an algorithmic flowchart for a full video sequence segmentation according to an embodiment of the method of the first aspect of the invention;

FIG. 3 is an algorithmic flowchart for 1 frame segmentation

FIG. 4 is a segmentation algorithmic block architecture

FIG. 5 illustrates an embodiment of the system of the second aspect of the invention; and

FIG. 6 shows, schematically, another embodiment of the system of the second aspect of the invention.

### DETAILED DESCRIPTION OF SEVERAL EMBODIMENTS

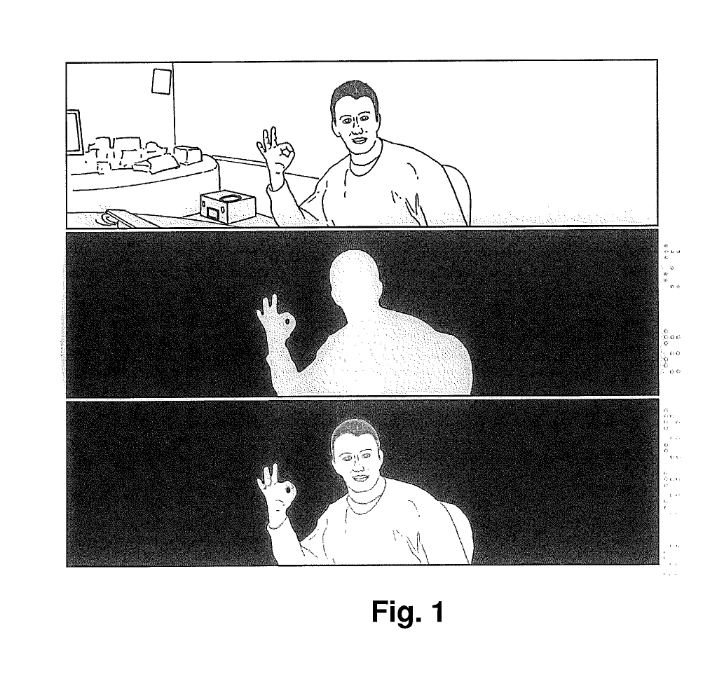

Upper view of FIG. 1 shows schematically a colour image on which the method of the first aspect of the invention has been applied, in order to obtain the foreground subject segmented out of the background, as illustrated by bottom view of FIG. 1, by performing a carefully studied sequence of image processing operations that lead to an enhanced and more flexible approach for foreground segmentation (where foreground is understood as the set of objects and surfaces that lay in front of a background).

In the method of the first aspect of the invention, the segmentation process is posed as a cost minimization problem. For a given pixel, a set of costs are derived from its probabilities to belong to the foreground, background or shadow classes. Each pixel will be assigned the label that has the lowest associated cost:

$${Pixel}_{Label} ( \vec{C} ) = {argmin}_{α ∈ \{ BG , FG , SH \}} \{ {Cost}_{α} ( \vec{C} ) \} . \qquad ( 1 )$$

In order to compute these costs, a number of steps are being taken such that they are as free of noise and outliers as possible. In this invention, this is done by computing costs region-wise on colour, temporally consistent, homogeneous areas followed by a robust optimization procedure. In order to achieve a good discrimination capacity among background, foreground and shadow, special care has been taken redesigning them as explained in the following.

In order to define the set of cost functions corresponding to the three segmentation classes, they have been built upon [6]. However, according to the method of the invention, the definitions of Background and Shadow costs are redefined in order to make them more accurate and reduce the temporal instability in the classification phase. For this, [4] has been revisited to thus derive equivalent background and shadow probability functionals based on chromatic distortion (3), colour distance and brightness (2) measures. Unlike in [4] though, where segmentation is fully defined to work on a threshold based classifier, the costs of the method of the invention are formulated from a Bayesian point of view. This is performed such that additive costs are derived after applying the logarithm to the probability expressions found. Thanks to this, costs are then used within the optimization framework chosen for this invention. In an example, brightness and colour distortion (with respect to a trained background model) are defined as follows. First, brightness (BD) is such that

$$BD ( \vec{C} ) = \frac{{C}_{r} \cdot {C}_{rm} + {C}_{g} \cdot {C}_{gm} + {C}_{b} \cdot {C}_{bm}}{{C}_{rm}^{2} + {C}_{gm}^{2} + {C}_{bm}^{2}} , \qquad ( 2 )$$

where \vec{C}={Cᵣ, C_{g}, C_{b}} is a pixel or segment colour with rgb components, and \vec{C}ₘ={Cᵣ_{ₘ}, C_{g}_{ₘ}, C_{b}_{ₘ}} is the corresponding trained mean for the pixel or segment colour in the background model.

The chroma distortion can be simply expressed as:

$$CD ( \vec{C} ) = \sqrt{( \begin{matrix}{( {C}_{r} - BD ( \vec{C} ) \cdot {C}_{rm} )}^{2} + \\ {( {C}_{g} - BD ( \vec{C} ) \cdot … {C}_{gm} )}^{2} + {( {C}_{b} - BD ( \vec{C} ) \cdot {C}_{bm} )}^{2}\end{matrix} )} . \qquad ( 3 )$$

Based on these, the method comprises defining the cost for Background as:

$${Cost}_{BG} ( \vec{C} ) = \frac{{‖ \vec{C} - {\vec{C}}_{m} ‖}^{2}}{5 \cdot {σ}_{m}^{2} \cdot {K}_{1}} + \frac{{CD ( \vec{C} )}^{2}}{5 \cdot {σ}_{CDm}^{2} \cdot {K}_{2}} , \qquad ( 4 )$$

where σₘ² represents the variance of that pixel or segment in the trained background model, and σ_{CD}_{ₘ}² is the one corresponding to the chromatic distortion. Akin to [6], the foreground cost can be just defined as:

$${Cost}_{FG} ( \vec{C} ) = \frac{16.64 \cdot {K}_{3}}{5} . \qquad ( 5 )$$

The cost related to shadow probability is defined by the method of the first aspect of the invention as:

$${Cost}_{SH} ( \vec{C} ) = \frac{{CD ( \vec{C} )}^{2}}{5 \cdot {σ}_{{CD}_{m}}^{2} \cdot {K}_{2}} + \frac{5 \cdot {K}_{4}}{{BD ( \vec{C} )}^{2}} - … log ( 1 - \frac{1}{\sqrt{2 \cdot π \cdot {σ}_{m}^{2} \cdot {K}_{1}}} ) . \qquad ( 6 )$$

In (4), (5) and (6), K₁, K₂, K₃ and K₄ are adjustable proportionality constants corresponding to each of the distances in use in the costs above. In this invention, thanks to the normalization factors in the expressions, once fixed all Kₓ parameters, results remain quite independent from scene, not needing additional tuning based on content.

The costs described above, while applicable pixel-wise in a straightforward way, would not provide satisfactory enough results if not used in a more structured computational framework. Robust segmentation requires, at least, to exploit the spatial structure of content beyond pixel-wise cost measure of foreground, background and shadow classes. For this purpose, in this invention, pixels' costs are locally estimated as an average over temporally stable, homogeneous colour regions [9] and then further regularized through a global optimization algorithm such as hierarchical believe propagation. That's carried out by the above referred steps i) to iv).

First of all, in step i), the image is over-segmented using homogeneous colour criteria. This is done by means of a k-means approach. Furthermore, in order to ensure temporal stability and consistency of homogeneous segments, a temporal correlation is enforced on k-means colour centroids in step ii). Then segmentation model costs are computed per colour segment, in step iii). After that, step iv) is carried out, i.e. using an optimization algorithm, such as hierarchical Belief Propagation [10], to find the best possible global solution (at a picture level) by optimizing and regularizing costs.

Optionally, and after step iv) has been carried out, the method comprises performing the final decision pixel or region-wise on final averaged costs computed over uniform colour regions to further refine foreground boundaries.

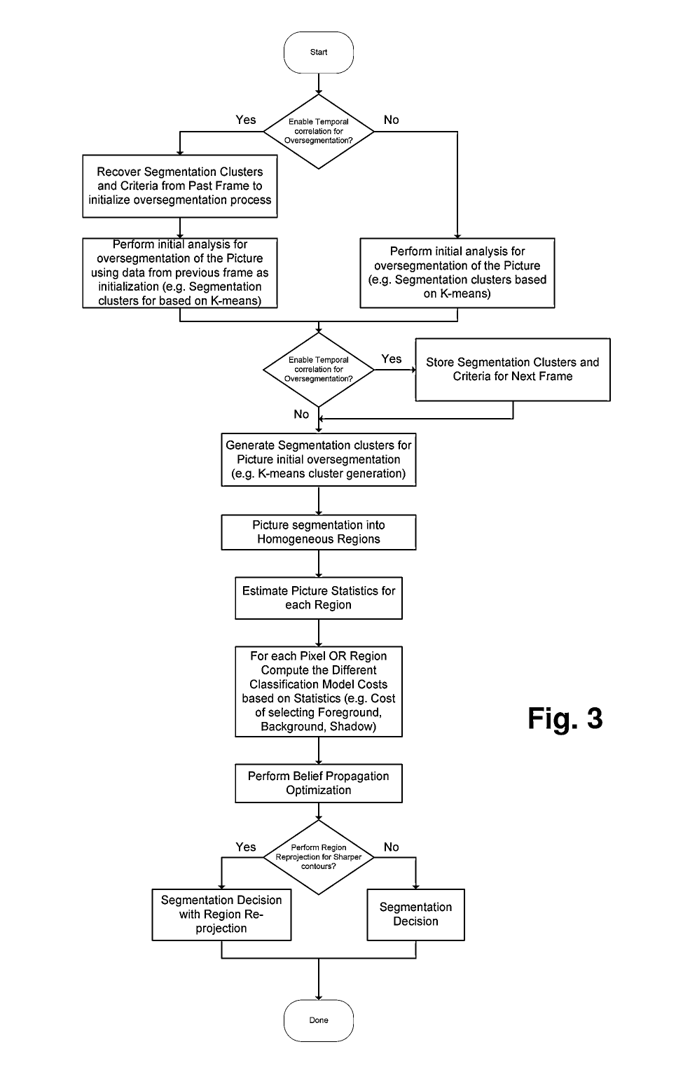

FIG. 3 depicts the block architecture of an algorithm implementing said steps i) to iv), and other steps, of the method of the first aspect of the invention.

In order to use the image's local spatial structure in a computationally affordable way, several methods have been considered taking into account also common hardware usually available in consumer or workstation computer systems. For this, while a large number of image segmentation techniques are available, they are not suitable to exploit the power of parallel architecture such as Graphics Processing Units (GPU) available on computers nowadays. Knowing that the initial segmentation is just going to be used as a support stage for further computation, a good approach for said step i) is a k-means clustering based segmentation [11]. K-means clustering is a well known algorithm for cluster analysis used in numerous applications. Given a group of samples (x₁, x₂, . . . , xₙ), where each sample is a d-dimensional real vector, in this case (R, G, B, x, y), where R, G and B are pixel colour components, and x, y are its coordinates in the image space, it aims to partition the n samples into k sets S=S₁, S₂, . . . , Sₖ such that:

$${argmin}_{s} {\sum }_{i = 1}^{k} {\sum }_{{X}_{j} ∈ {S}_{i}} {‖ {X}_{j} - {μ}_{i} ‖}^{2} ,$$

where μᵢ is the mean of points in Sᵢ. Clustering is a hard time consuming process, mostly for large data sets.

The common k-means algorithm proceeds by alternating between assignment and update steps:
Assignment: Assign each sample to the cluster with the closest mean.

Sᵢ^{(t)}={Xⱼ:∥Xⱼ−μᵢ^{(t)}∥≦∥Xⱼ−μ_{i*}^{(t)}∥, . . . ∀i*=1, . . . k}
Update: Calculate the new means to be the centroid of the cluster.

$${μ}_{i}^{( t + 1 )} = \frac{1}{\vert {S}_{i}^{( t )} \vert} {\sum }_{{X}_{j} ∈ {S}_{i}^{( t )}} {X}_{j}$$

The algorithm converges when assignments no longer change.

According to the method of the first aspect of the invention, said k-means approach is a k-means clustering based segmentation modified to fit better to the problem and the particular GPU architecture (i.e. number of cores, threads per block, etc. . . . ) to be used.

Modifying said k-means clustering based segmentation comprises constraining the initial Assignment set (μ₁⁽¹⁾ , , , μₖ⁽¹⁾) to the parallel architecture of GPU by means of a number of sets that also depend on the image size. The input is split into a grid of n×n squares, achieving

$$\frac{( M \times N )}{{n}^{2}}$$

clusters where N and M are the image dimensions. The initial Update step is computed from the pixels within these regions. With this the algorithm is helped to converge in a lower number of iterations.

A second constraint introduced, as part of said modification of the k-means clustering based segmentation, is in the Assignment step. Each pixel can only change cluster assignment to a strictly neighbouring k-means cluster such that spatial continuity is ensured.

The initial grid, and the maximum number of iterations allowed, strongly influences the final size and shape of homogeneous segments. In these steps, n is related to the block size used in the execution of process kernels within the GPU. The above constraint leads to:

Sᵢ^{(t)}={Xⱼ:∥Xⱼ−μ₂^{(t)}∥≦∥Xⱼ−μ_{i*}^{(t)}∥,∀i*εN(i)}

where N (i) is the neighbourhood of cluster i (in other words the set of clusters that surround cluster i), and Xⱼ is a vector representing a pixel sample (R, G, B, x, y), where R, G, B represent colour components in any selected colour space and x, y are the spatial position of said pixel in one of said pictures.

For a preferred embodiment the method of the first aspect of the invention is applied to a plurality of images corresponding to different and consecutive frames of a video sequence.

For video sequences where there is a strong temporal correlation from frame to frame, the method further comprises using final resulting centroids after k-means segmentation of a frame to initialize the oversegmentation of the next one, thus achieving said enforcing of a temporal correlation on k-means colour centroids, in order to ensure temporal stability and consistency of homogeneous segments of step ii). IN other words, this helps to further accelerate the convergence of the initial segmentation while also improving the temporal consistency of the final result between consecutive frames.

Resulting regions of the first over-segmentation step of the method of the invention are small but big enough to account for the image's local spatial structure in the calculation. In terms of implementation, in an embodiment of this invention, the whole segmentation process is developed in CUDA (NVIDIA C extensions for their graphic cards). Each step, assignment and update, are built as CUDA kernels for parallel processing. Each of the GPU's thread works only on the pixels within a cluster. The resulting centroid data is stored as texture memory while avoiding memory misalignment. A CUDA kernel for the Assignment step stores per pixel in a register the decision. The Update CUDA kernel looks into the register previously stored in texture memory and computes the new centroid for each cluster. Since real-time is a requirement for our purpose, the number of iterations can be limited to n, where n is the size of initialization grid in this particular embodiment.

After the initial geometric segmentation, the next step is the generation of the region-wise averages for chromatic distortion (CD), Brightness (BD) and other statistics required in Foreground/Background/Shadow costs. Following to that, the next step is to find a global solution of the foreground segmentation problem. Once we have considered the image's local spatial structure through the regularization of the estimation costs on the segments obtained via our customized k-means clustering method, we need a global minimization algorithm to exploit global spatial structure which fits our real-time constraints. A well known algorithm is the one introduced in [10], which implements a hierarchical belief propagation approach. Again, a CUDA implementation of this algorithm is in use in order to maximize parallel processing within every of its iterations. Specifically, in an embodiment of this invention three levels are being considered in the hierarchy with 8, 2 an 1 iterations per level (from finer to coarser resolution levels). In an embodiment of the invention, one can assign less iterations for coarser layers of the pyramid, in order to balance speed of convergence with resolution losses on the final result. A higher number of iterations in coarser levels makes the whole process converge faster but also compromises the accuracy of the result on small details. Finally, the result of the global optimization step is used for classification based on (1), either pixel-wise or region-wise with a re-projection into the initial regions obtained from the first over-segmentation process in order to improve the boundaries accuracy.

For an embodiment, the method of the invention comprises using the results of step iv) to carry out a classification based on either pixel-wise or region-wise with a re-projection into the segmentation space in order to improve the boundaries accuracy of said foreground.

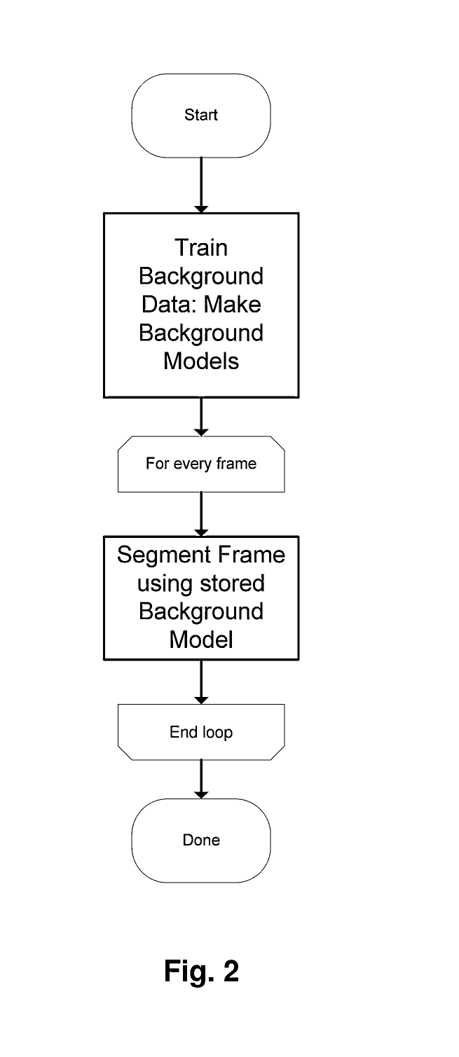

Referring now to the flowchart of FIG. 2, there a general segmentation approach used to process sequentially each picture, or frame of a video sequence, according to the method of the first aspect of the invention, is shown, where Background Statistics Models defined above are made from trained Background data, and where the block “Segment Frame Using a Stored Background Model” corresponds to the segmentation operation that uses the set of cost functionals for Foreground, Background and Shadow defined above, and steps i) to iv) defined above. with the previously stored trained Background Model (i.e. σₘ², σ_{CD}_{ₘ}², \vec{C}ₘ={Cᵣ_{ₘ}, C_{g}_{ₘ}, C_{b}_{ₘ}}) . . . .

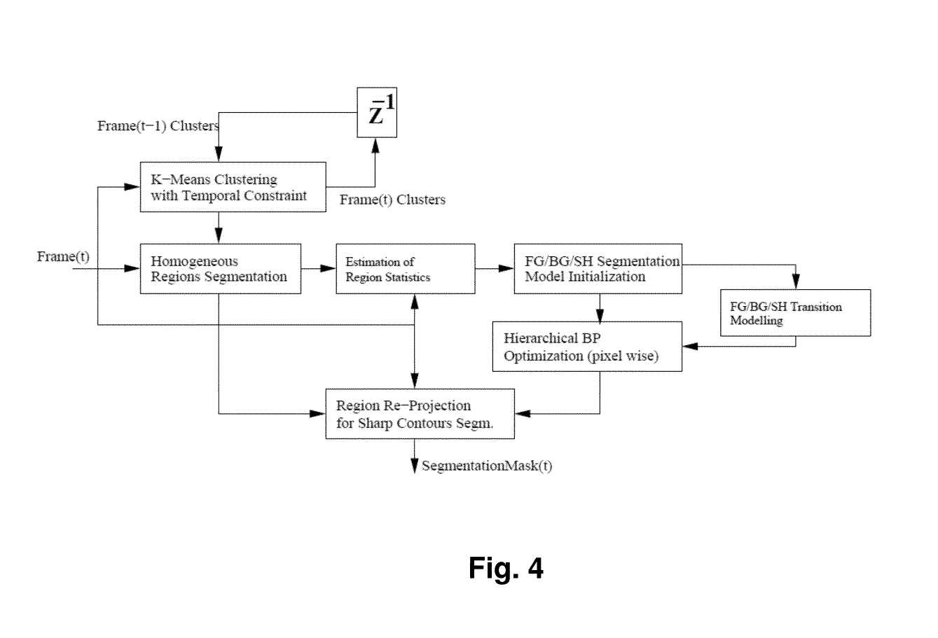

FIG. 4 shows the general block diagram related to the method of the first aspect of the invention. It basically shows the connectivity between the different functional modules that carry out the segmentation process.

As seen in the picture, every input frame is processed in order to generate a first over-segmented result of connected regions. This is done in a Homogeneous Regions segmentations process, which among other, can be based on a region growing method using K-means based clustering. In order to improve temporal and spatial consistency, segmentation parameters (such as k-means clusters) are stored from frame to frame in order to initialize the over-segmentation process in the next input frame.

The first over-segmented result is then used in order to generate regularized region-wise statistical analysis of the input frame. This is performed region-wise, such that colour, brightness, or other visual features are computed in average (or other alternatives such as median) over each region. Such region-wise statistics are then used to initialize a region or pixel-wise foreground/Background shadow Costs model. This set of costs per pixel or per region is then cross-optimized by an optimization algorithm that, among other may be Belief Propagation or hierarchical Belief Propagation for instance.

After optimizing the initial Foreground/Background/Shadow costs, this are then analyzed in order to decide what is foreground and what background is. This is done either pixel wise or it can also be done region-wise using the initial regions obtained from the over-segmentation generated at the beginning of the process.

The above indicated re-projection into the segmentation space, in order to improve the boundaries accuracy of the foreground, is also included in the diagram of FIG. 4, finally obtaining a segmentation mask or segment as the one corresponding to the middle view of FIG. 1, and a masked scene as the one of the bottom view of FIG. 1.

FIG. 3 depicts the flowchart corresponding to the segmentation processes carried by the method of the second aspect of the invention, for an embodiment including different alternatives, such as the one indicated by the disjunctive box, questioning if performing a region reprojection for sharper contours.

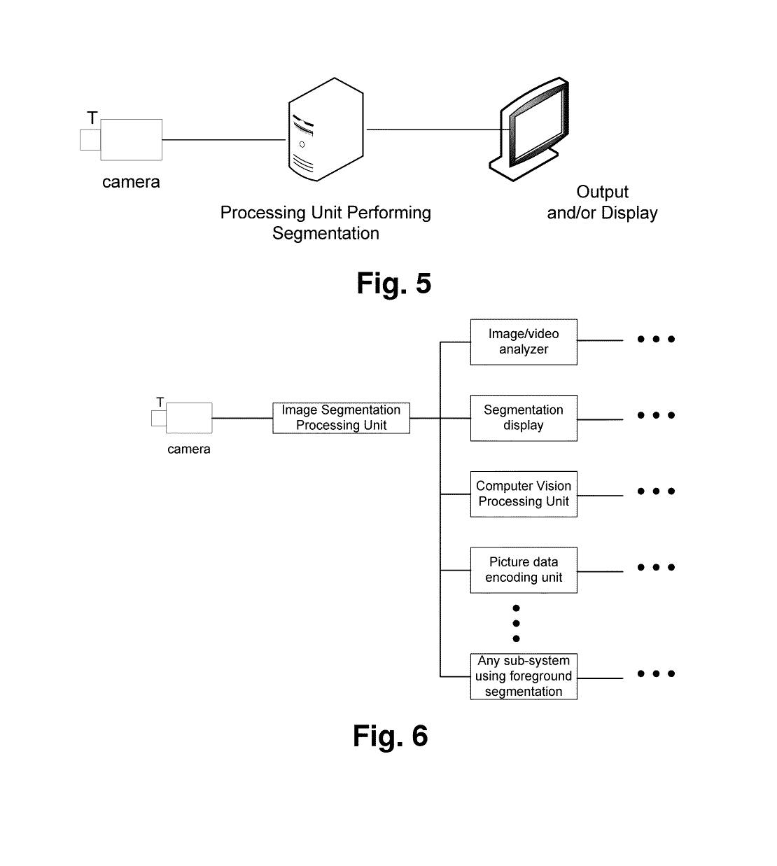

Regarding the system provided by the second aspect of the invention, FIG. 5 illustrates a basic embodiment thereof, including a colour camera to acquire colour images, a processing unit comprised by the previously indicated processing means, and an output and/or display for delivering the results obtained.

Said processing unit can be any computationally enabled device, such as dedicated hardware, a personal computer, and embedded system, etc. . . . and the output of such a system after processing the input data can be used for display, or as input of other systems and sub-systems that use a foreground segmentation.

For some embodiments, the processing means are intended also for generating real and/or virtual three-dimensional images, from silhouettes generated from the images foreground segmentation, and displaying them through said display.

For an embodiment, the system constitutes or forms part of a Telepresence system.

A more detailed example is shown in FIG. 6, where it depicts that after the processing unit that creates a segmented version of the input and that as output can give the segmented result plus, if required, additional data at the input of the segmentation module. The input of the foreground segmentation module (an embodiment of this invention) can be generated by a camera. The output can be used in at least one of the described processes: image/video analyzer, segmentation display, computer vision processing unit, picture data encoding unit, etc. . . . .

In a more complex system, an embodiment of this invention can be used as an intermediate step for a more complex processing of the input data.

This invention is a novel approach for robust foreground segmentation for real-time operation on GPU architectures.
This approach is suitable for combination with other computer vision and image processing techniques such as real-time depth estimation algorithms for stereo matching acceleration, flat region outlier reduction and depth boundary enhancement between regions.
This approach is able to exploit both picture local geometric structures as well as global picture structures for improved segmentation robustness.
The statistical models provided in this invention, plus the use of over-segmented regions for statistics estimation have been able to make the foreground segmentation more stable in space and time, while usable in real-time on current market-available GPU hardware.
The invention also provides the functionality of being “scalable” in complexity. This is, the invention allows for adapting the trade-off between final result accuracy and computational complexity as a function of at least one scalar value. Allowing to improve segmentation quality and capacity to process bigger images as GPU hardware becomes better and better.
The invention provides a segmentation approach that overcomes limitations of currently available state of the art. The invention does not rely on ad-hoc closed-contour object models, and allows detecting and to segment foreground objects that include holes and highly detailed contours.
The invention exploits local and global picture structure in order to enhance the segmentation quality, its spatial consistency and stability as well as its temporal consistency and stability.
The invention provides also an algorithmic structure suitable for easy, parallel multi-core and multi-thread processing.
The invention provides a segmentation method resilient to shading changes and resilient to foreground areas with weak discrimination with respect to the background if these “weak” areas are small enough.
The invention does not rely on any high level model, making it applicable in a general manner to different situations where foreground segmentation is required (independently of the object to segment or the scene).

A person skilled in the art could introduce changes and modifications in the embodiments described without departing from the scope of the invention as it is defined in the attached claims.

### REFERENCES

[1] Patent Definition. http://en.wikipedia.org/wiki/Patent.
[2] O. Divorra Escoda, J. Civit, F. Zuo, H. Belt, I. Feldmann, O. Schreer, E. Yellin, W. Ijsselsteijn, R. van Eijk, D. Espinola, P. Hagendorf, W. Waizenneger, and R. Braspenning, “Towards 3d-aware telepresence: Working on technologies behind the scene,” in New Frontiers in Telepresence workshop at ACM CSCW, Savannah, Ga., February 2010.
[3] C. L. Kleinke, “Gaze and eye contact: A research review,”Psychological Bulletin, vol. 100, pp. 78-100, 1986. [3] A. Elgammal, R. Duraiswami, D. Harwood, and L. S. Davis, “Non-parametric model for background subtraction,” in Proceedings of International Conference on Computer Vision. September 1999, IEEE Computer Society.
[4] T. Horpraset, D. Harwood, and L. Davis, “A statistical approach for real-time robust background subtraction and shadow detection,” in IEEE ICCV, Kerkyra, Greece, 1999.
[5] J. L. Landabaso, M. Pardas, and L.-Q. Xu, “Shadow removal with blob-based morphological reconstruction for error correction,” in IEEE ICASSP, Philadelphia, Pa., USA, March 2005.
[6] J.-L. Landabaso, J.-C Pujol, T. Montserrat, D. Marimon, J. Civit, and O. Divorra, “A global probabilistic framework for the foreground, background and shadow classification task,” in IEEE ICIP, Cairo, November 2009.
[7] J. Gallego Vila, “Foreground segmentation and tracking based on foreground and background modeling techniques,” M. S. thesis, Image Processing Department, Technical University of Catalunya, 2009.
[8] I. Feldmann, O. Schreer, R. Shfer, F. Zuo, H. Belt, and O. Divorra Escoda, “Immersive multi-user 3d video communication,” in IBC, Amsterdam, The Netherlands, September 2009.
[9] C. Lawrence Zitnick and Sing Bing Kang, “Stereo for imagebased rendering using image over-segmentation,” in International Journal in Computer Vision, 2007.
[10] P. F. Felzenszwalb and D. P. Huttenlocher, “Efficient belief propagation for early vision,” in CVPR, 2004, pp. 261-268.
[11] J. B. MacQueen, “Some methods for classification and analysis of multivariate observations,” in Proc. of the fifth Berkeley Symposium on Mathematical Statistics and Probability, L. M. Le Cam and J. Neyman, Eds. 1967, vol. 1, pp. 281-297, University of California Press.
[12] O. Schreer N. Atzpadin, P. Kauff, “Stereo analysis by hybrid recursive matching for real-time immersive video stereo analysis by hybrid recursive matching for real-time immersive video conferencing,” vol. 14, no. 3, March 2004.

1. Method for real-time images foreground segmentation, comprising:
generating a set of cost functions for foreground, background and shadow segmentation classes or models, where the background and shadow segmentation costs are based on chromatic distortion and brightness and colour distortion, and where said cost functions are related to probability measures of a given pixel or region to belong to each of said segmentation classes; and
applying to the pixels of an image said set of generated cost functions;
said method being characterised in that it comprises, in addition to a local modelling of foreground, background and shadow classes carried out by said cost functions, exploiting the spatial structure of content of at least said image in a local as well as more global manner; this is done such that local spatial structure is exploited by estimating pixels' costs as an average over homogeneous colour regions, and global spatial structure is exploited by the use of a regularization optimization algorithm.

2. Method as per claim 1, comprising applying a logarithm operation to the probability expressions obtained according to a Bayesian formulation in order to derive additive costs.

3. Method as per claim 1, comprising defining said brightness distortion as:
$$BD ( \vec{C} ) = \frac{{C}_{r} \cdot {C}_{rm} + {C}_{g} \cdot {C}_{gm} + {C}_{b} \cdot {C}_{bm}}{{C}_{rm}^{2} + {C}_{gm}^{2} + {C}_{bm}^{2}}$$
$$\vec{C} = \{ {C}_{r} , {C}_{g} , {C}_{b} \}$$
where is a pixel or segment colour with r, g, b components, and \vec{C}ₘ={Cᵣ_{ₘ}, C_{g}_{ₘ}, C_{b}_{ₘ}} is the corresponding trained mean for the pixel or segment colour in a trained background model.

4. Method as per claim 3, comprising defining said chromatic distortion as:
$$CD ( \vec{C} ) = \sqrt{( \begin{matrix}{( {C}_{r} - BD ( \vec{C} ) \cdot {C}_{rm} )}^{2} + \\ {( {C}_{g} - BD ( \vec{C} ) \cdot … {C}_{gm} )}^{2} + {( {C}_{b} - BD ( \vec{C} ) \cdot {C}_{bm} )}^{2}\end{matrix} )} .$$

5. Method as per claim 4, comprising defining said cost function for the background segmentation class as:
$${Cost}_{BG} ( \vec{C} ) = \frac{{‖ \vec{C} - {\vec{C}}_{m} ‖}^{2}}{5 \cdot {σ}_{m}^{2} \cdot {K}_{1}} + \frac{{CD ( \vec{C} )}^{2}}{5 \cdot {σ}_{CDm}^{2} \cdot {K}_{2}}$$
where K₁ and K₂ are adjustable proportionality constants corresponding to the distances in use in said background cost function, σₘ² represents the variance of that pixel or segment in the background, and σ_{CD}_{ₘ}² is the one corresponding to the chromatic distortion.

6. Method as per claim 5, comprising defining said cost function for the foreground segmentation class as:
$${Cost}_{FG} ( \vec{C} ) = \frac{16.64 \cdot {K}_{3}}{5} .$$
where K₃ is an adjustable proportionality constant corresponding to the distances in use in said foreground cost function.

7. Method as per claim 6, comprising defining said cost function for the shadow class as:
$${Cost}_{SH} ( \vec{C} ) = \frac{{CD ( \vec{C} )}^{2}}{5 \cdot {σ}_{{CD}_{m}}^{2} \cdot {K}_{2}} + \frac{5 \cdot {K}_{4}}{{BD ( \vec{C} )}^{2}} - … log ( 1 - \frac{1}{\sqrt{2 \cdot π \cdot {σ}_{m}^{2} \cdot {K}_{1}}} ) .$$
where K₄ is an adjustable proportionality constant corresponding to the distances in use in said shadow cost function.

8. Method as per claim 1, wherein said estimating of pixels' costs is carried out by the next sequential actions:
i) over-segmenting the image using a homogeneous colour criteria based on a k-means approach;
ii) enforcing a temporal correlation on k-means colour centroids, in order to ensure temporal stability and consistency of homogeneous segments,
iii) computing said cost functions per colour segment;
and said global spatial structure is exploited by:
iv) using an optimization algorithm to find the best possible global solution by optimizing costs.

9. Method as per claim 8, wherein said optimization algorithm is a hierarchical Belief Propagation algorithm.

10. Method as per claim 8, comprising, after said step iv) has been carried out, performing the final decision pixel or region-wise on final averaged costs computed over uniform colour regions to further refine foreground boundaries.

11. Method as per claim 8, wherein said k-means approach is a k-means clustering based segmentation modified to fit a graphics processing unit, or GPU, architecture.

12. Method as per claim 11, wherein modifying said k-means clustering based segmentation comprises constraining the initial Assignment set (μ₁⁽¹⁾ , , , μₖ⁽¹⁾) to the parallel architecture of GPU by means of a number of sets that also depend on the image size, by means of splitting the input into a grid of n×n squares, where n is related to the block size used in the execution of process kernels within the GPU, achieving
$$\frac{( M \times N )}{{n}^{2}}$$
clusters, where N and M are the image dimensions, and μᵢ is the mean of points in set of samples Sᵢ, and computing the initial Update step of said k-means clustering based segmentation from the pixels within said squared regions, such that an algorithm implementing said modified k-means clustering based segmentation converges in a lower number of iterations.

13. Method as per claim 12, wherein modifying said k-means clustering based segmentation further comprises, in the Assignment step of said k-means clustering based segmentation, constraining the clusters to which each pixel can change cluster assignment to a strictly neighbouring k-means cluster, such that spatial continuity is ensured.

14. Method as per claim 13, wherein said constraints lead to the next modified Assignment step:
Sᵢ^{(t)}={Xⱼ:∥Xⱼ−μ₂^{(t)}∥≦∥Xⱼ−μ_{i*}^{(t)}∥,∀i*εN(i)}
where N (i) is the neighbourhood of cluster i, and Xⱼ is a vector representing a pixel sample (R, G, B, x, y), where R, G, B represent colour components in any selected colour space and x, y are the spatial position of said pixel in one of said pictures.

15. Method as per claim 1, wherein it is applied to a plurality of images corresponding to different and consecutive frames of a video sequence.

16. Method as per claim 14, the method is applied to a plurality of images corresponding to different and consecutive frames of a video sequence, wherein for video sequences where there is a strong temporal correlation from frame to frame, the method comprises using final resulting centroids after k-means segmentation of a frame to initialize the oversegmentation of the next one, thus achieving said enforcing of a temporal correlation on k-means colour centroids, in order to ensure temporal stability and consistency of homogeneous segments.

17. Method as per claim 16, comprising using the results of step iv) to carry out a classification based on either pixel-wise or region-wise with a re-projection into the segmentation space in order to improve the boundaries accuracy of said foreground.

18. System for real-time images foreground segmentation, comprising at least a camera, processing means connected to said camera to receive images acquired there by and to process them in order to carry out a real-time images foreground segmentation, characterised in that said processing means are intended for carrying out said foreground segmentation by hardware and/or software elements implementing at least steps i) to iv) of the method as per claim 8.

19. System as per claim 18, comprising a display connected to the output of said processing means, the latter being intended also for generating real and/or virtual three-dimensional images, from silhouettes generated from said images foreground segmentation, and displaying them through said display.

20. System as per claim 19, characterised in that it constitutes or forms part of a Telepresence system.
